(19) United States
(12) Patent Application Publication
(10) Pub. No.: US 2013/0240152 A1
(43) Pub. Date: Sep. 19, 2013

(54) HOLLOW TIP WELDING TOOL

(71) Applicants: PATRICK CONALL REGAN, TAICHUNG CITY (TW); KUO-HUNG LEE, YUNLIN COUNTY (TW); CHIH-CHI CHANG, YUNLIN COUNTY (TW)

(72) Inventors: PATRICK CONALL REGAN, TAICHUNG CITY (TW); KUO-HUNG LEE, YUNLIN COUNTY (TW); CHIH-CHI CHANG, YUNLIN COUNTY (TW)

(73) Assignee: NIKE, INC., BEAVERTON, OR (US)

(21) Appl. No.: 13/421,514

(22) Filed: Mar. 15, 2012

(51) Int. Cl. B32B 37/06; B23K 20/10

(52) U.S. Cl. 156/580.1; 228/1.1

(57) ABSTRACT

Embodiments of the present invention relate to a hollow-tipped ultrasonic welding and vacuum tool. The tool is comprised of a horn coupled to a converter for transferring an ultrasonic mechanical vibration to a part-contacting distal end of the horn. The horn is comprised of a vacuum channel that extends from an exterior surface of the horn through an interior portion of the horn to the part-contacting distal end of the horn. The vacuum channel may provide a channel through which a vacuum force may be focused to a part that is to be positioned and welded with a common part-contacting surface.

### CROSS-REFERENCE TO RELATED APPLICATION

This application having attorney docket number NIKE.162501, entitled “HOLLOW TIP WELDING TOOL” is related by subject matter to U.S. patent application Ser. No. 13/299,908, filed Nov. 18, 2011, having attorney docket number NIKE.162500, and entitled “MULTI-FUNCTIONAL MANUFACTURING TOOL.” Further, this application is also related by subject matter to U.S. patent application Ser. No. 13/299,934, filed Nov. 18, 2011, having attorney docket number NIKE.162096, and entitled “MANUFACTURING VACUUM TOOL.” The entireties of the aforementioned applications are incorporated by reference herein.

### BACKGROUND

Traditionally, parts used in manufacturing a product are picked up and placed in a position for manufacturing by human hand or robotic means. However, current robotic means have not provided a level of control, dexterity, and effectiveness to be cost-effectively implemented in some manufacturing systems.

Automated manufacturing systems that implement a variety of processes have traditionally relied on discrete mechanisms to implement each of the different processes. However, having automation machinery dedicated to a primarily-discrete task may be inefficient from a production perspective and from a cost perspective.

### SUMMARY

Aspects of the present invention relate to systems, methods and apparatus for an ultrasonic welding vacuum tool. The ultrasonic welding vacuum tool is comprised of a converter for converting electrical input into an ultrasonic mechanical vibration. The ultrasonic welding vacuum tool is further comprised of a horn coupled to the converter for transferring the ultrasonic mechanical vibration to a part-contacting distal end of the horn, the horn comprised of a vacuum channel. The vacuum channel extending from an exterior surface of the horn through an interior portion of the horn to the part-contacting distal end of the horn.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 depicts an exemplary ultrasonic welding vacuum tool, in accordance with aspects of the present invention;

FIG. 2 depicts another exemplary aspect of the pick-up tool having an integrated vacuum generator, in accordance with aspects of the present invention;

FIG. 3 depicts a perspective view of a pick-up tool mounted within a coupler, in accordance with aspects of the present invention;

FIG. 4 depicts an internal view of the pick-up tool along cutline 4-4 of FIG. 1, in accordance with aspects of the present invention;

FIG. 5 depicts an internal view of the pick-up tool along cutline 5-5 of FIG. 2, in accordance with aspects of the present invention;

FIG. 6 depicts an internal view of an exemplary pick-up tool utilizing an alternative internal vacuum mechanism, in accordance with aspects of the present invention;

FIG. 7 depicts an exemplary horn having a coanda effect internal vacuum generator, in accordance with aspects of the present invention;

FIG. 8 depicts an exemplary horn coupled with an exemplary horn tip, in accordance with aspects of the present invention; and

FIGS. 9-17 depict exemplary aperture patterns, in accordance with aspects of the present invention.

### DETAILED DESCRIPTION

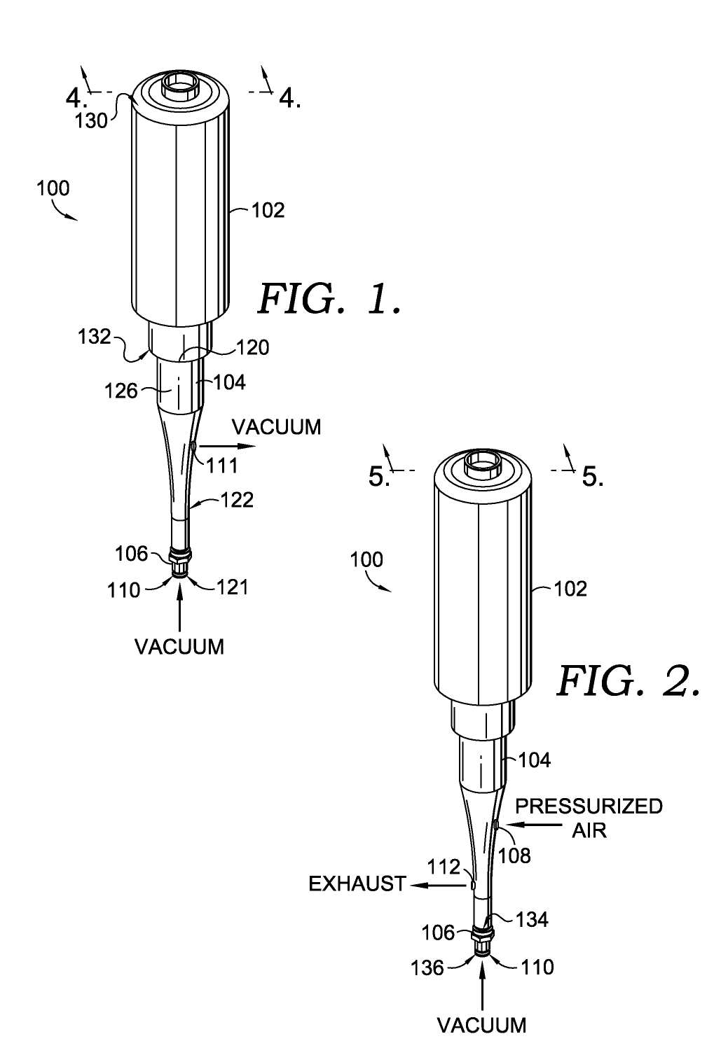

FIG. 1 depicts an exemplary ultrasonic welding vacuum tool 100, in accordance with aspects of the present invention. The ultrasonic welding vacuum tool 100 may also be referred to as a pick-up tool 100 herein. An ultrasonic welder, in general, is comprised of a stack. The stack is comprised of a converter 102 and a horn 104. The converter 102 converts an electrical signal into a mechanical vibration, such as an ultrasonic vibration (the converter 102 may also be referred to as a transducer, such as a piezoelectric transducer). The horn 104, traditionally, transfers the mechanical vibration produced by the converter 102 to a manufacturing part to be welded (the horn may also be referenced to as a sonotrode). Additional components of an ultrasonic welder stack may traditionally include a booster (not shown). The booster modifies amplitude of vibration produced by the converter 102 to be transmitted by the horn 104. In an exemplary aspect, the booster is useable to couple the ultrasonic welder stack to a moveable member, such as a press manufacturing or a computer-numerically-controlled robot.

An ultrasonic welder may further be comprised of an electronic ultrasonic generator (may also be referred to as a power supply) and a controller. The electronic ultrasonic generator may be useable for delivering a high-powered alternating current signal with a frequency matching a resonance frequency of the stack (e.g., horn, converter, and booster). The controller controls the delivery of the ultrasonic energy from the ultrasonic welder to one or more parts.

While the converter 102 is depicted herein as a cylindrical in shape, it is contemplated that other formations are applicable. The converter 102 of FIG. 1 has a first end 130 and a second end 132.

The horn 104 is generally depicted as having a circular cross-section within FIG. 1; however, it is contemplated that additional cross-sectional geometries may be implemented. For example, to provide one or more mechanical vibration traits, the cross-sectional shape may be altered. In particular, it is contemplated that a variety of curved geometries utilizing one or more diameters may be implemented. Further, it is contemplated that one or more non-curved geometries (e.g., rectangular, triangular, star-like, and the like) may also be implemented in exemplary aspects.

The horn 104 may be constructed from a rigid or semi-rigid material, such as a metallic material and/or a polymer-based material. In an exemplary embodiment, the horn 104 is constructed from aluminum, copper, steel, brass, titanium, and/or the like. Further, it is contemplated that the horn 104 may be constructed from a nylon, polyethylene, polycarbonates, polypropylene, polyvinyl, and/or other thermo-formed or thermo-set plastics. The horn tip 106 may also be constructed/formed from one or more similar materials.

The horn 104 has a proximal end 120 and a distal end 122. The distal end 122, in some aspects is also a part-contacting distal end 121. However, in other aspects, the horn 104 is further comprised of the horn tip 106. When a horn tip 106 is coupled (either permanently coupled or removeably coupled) to the horn 104, the horn distal end 122 may provide a coupling location for the horn tip 106 as opposed to serving as the part-contacting distal end 121.

The horn tip 106 may be positioned at a distal portion of the pick-up tool 100. In an exemplary aspect, it is contemplated that the horn tip 106 is removeably coupled to the horn 104 such that different horn tips may be utilized depending on one or more variables (e.g., desired vacuum force, desired ultrasonic welding surface area, to-be-welded part material, and the like). For example, it is contemplated that the horn tip 106 may couple to the horn 104 utilizing a threading mechanism, a compression fit, an adhesive, a mechanical connector, and the like. As a result, depending on the desired characteristics of the pick-up tool 100, the horn tip 106 may be changed/altered.

In use, it is contemplated that the pick-up tool 100 is functional for exerting a vacuum force on a part to be welded such that the pick-up tool 100 can either maintain the part in a particular location/orientation and/or to reposition the part. For example, during the construction of a shoe upper, one or more pieces of malleable materials (e.g., leather, nylon, foam, mesh) may be picked up and positioned on top of another material (or portion of material) to be secured at that location/orientation. The parts may then be secured utilizing a variety of techniques, including ultrasonic welding. Therefore, the ability to pick a part up, place the part, maintain the part, and also secure the part utilizing a common tool is desired in an aspect of the present invention.

To exert the vacuum force useable for moving, maintain, and/or placing a part, it is contemplated that the horn 104 itself acts as a conduit for the vacuum force. Therefore, it is contemplated that the horn 104 transfers ultrasonic vibrations and also provides a means for exerting a vacuum force on the material. To exert the vacuum force, it is contemplated that a vacuum force is generated within the horn 104 and/or a vacuum force is generated external (e.g., by way of a mechanical vacuum pump, by way of a venturi effect vacuum pump, by way of a coanda effect vacuum pump) to the horn 104 and transferred to the horn 104 by way of one or more means (e.g., channels, tubing, and other conduits).

As will be discussed in more detail hereinafter, it is contemplated that a venturi effect vacuum pump is integrated within at least a portion of an internal volume of the horn 104. Further, it is contemplated that a coanda effect vacuum pump is integrated within at least a portion of the internal volume of the horn 104.

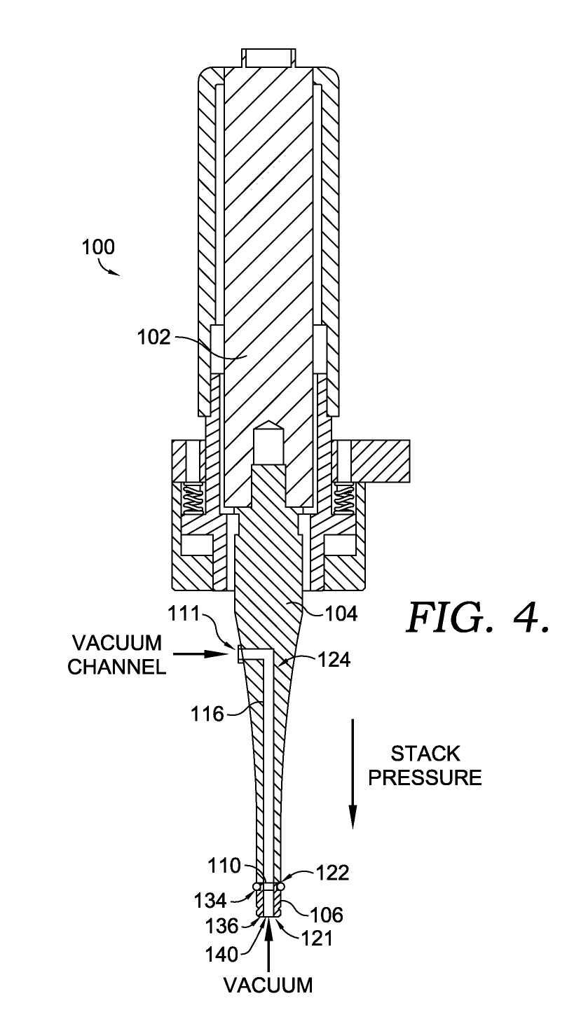

FIG. 1 depicts the pick-up tool 100 capable of generating a vacuum force at the part-contacting distal end 121 utilizing an external vacuum source that is coupled (either removeably or permanently) to the horn 104 by way of a vacuum source port 111. For example, it is contemplated that a remote vacuum pump (e.g., an electrically operated pump, a pressurized air pump) is flexibly coupled to the pick-up tool 100 by way of a length of flexible tubing (not shown). The flexible tubing is functional to maintain a portion of the vacuum force generated by the remote vacuum pump such that the vacuum force is introduced to an internal channel within the horn 104 (to be discussed with respect to FIG. 4 hereinafter). The vacuum force passes through the horn 104, by way of the internal channel, to the part-contacting distal end 121 at a vacuum inlet 110. As a result of this transfer of the vacuum force, the pick-up tool 100 is functional for exerting the vacuum force on a part proximate to a point at which the pick-up tool 100 is also capable of ultrasonically welding the part. Further, it is contemplated that a smaller footprint may be recognized by integrating the pickup portion and the welding portion of the pick-up tool 100.

The vacuum pick-up tool 100 of FIG. 1 depicts a cutline 4-4 that depicts an internal cut view of the pick-up tool 100 of FIG. 1 in FIG. 4, to be discussed hereinafter.

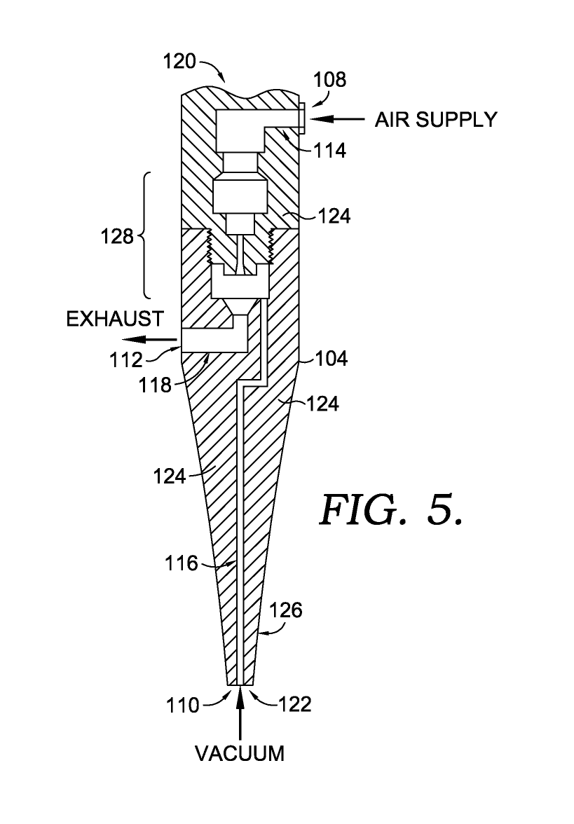

FIG. 2 depicts another exemplary aspect of the pick-up tool 100 having an integrated vacuum generator, in accordance with aspects of the present invention. As will be discussed in greater detail with respect to FIG. 5 hereinafter, the pick-up tool 100 may be comprised of a vacuum generator 128 (not shown in FIG. 2). The vacuum generator 128 may be any type of vacuum generator. In particular, it is contemplated that a venturi effect vacuum generator is utilized. Further, it is contemplated that a coanda effect vacuum generator is utilized. Either the venturi or the coanda effect vacuum generator may be implemented with the basic configuration depicted at FIG. 2.

The internal generation of a vacuum force may provide advantages such as greater durability (e.g., fewer remote parts), great control (e.g., fewer variables to the generated vacuum force as realized at the vacuum inlet 110), smaller footprint (e.g., less space utilized by a remote device), and the like. However, both internal generation of vacuum force and external generation of vacuum force may be desired in various aspects.

The pick-up tool 100 of FIG. 2 receives pressurized air at an air-supply inlet 108. The pressurized air is used to generate a vacuum force internally. The vacuum force that is generated internally draws in ambient air by way of the vacuum inlet 110. As a result of a pressure gradient (i.e., lower pressure on an internal side of the vacuum inlet 110 and a higher relative pressure (e.g., ambient air pressure) on an external side of the vacuum inlet 110), a vacuum force is experienced by a part proximate the vacuum inlet 110. This vacuum force allows the pick-up tool 100 to manipulate the part (e.g., orientation, location, position).

The pressurized air and air that is introduced by way of the vacuum inlet 110 are passed from an interior volume of the horn 104 by way of an exhaust port 112. While the pick-up tool 100 of FIG. 2 depicts the air-supply inlet 108 and the exhaust port 112 offset, it is contemplated that a relative orientation between the two may be altered (e.g., parallel and similarly positioned).

FIG. 2 depicts the horn tip 106 having a proximal end 134 and a distal end 136. In an exemplary aspect, the horn distal end 136 is also the part-contacting distal end 121, discussed previously.

The vacuum pick-up tool 100 of FIG. 2 depicts a cutline 5-5 that represents an internal cut view of the pick-up tool 100 of FIG. 2 in FIG. 5, to be discussed hereinafter.

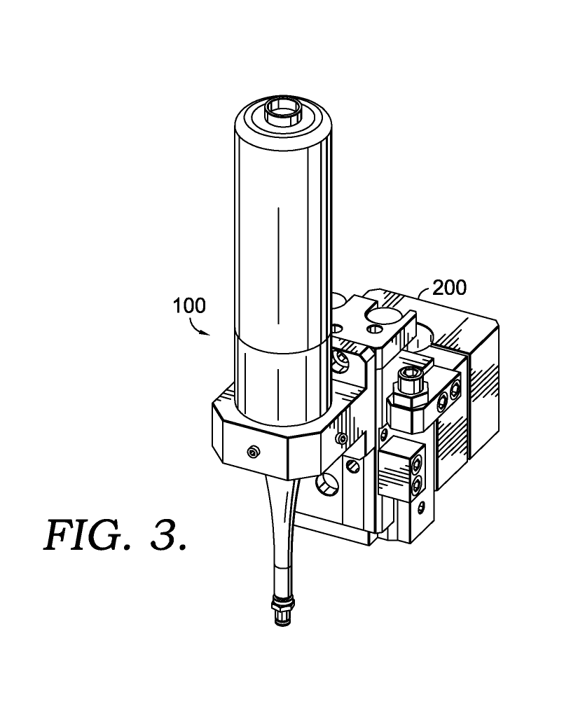

FIG. 3 depicts a perspective view of a pick-up tool 100 mounted within a coupler 200, in accordance with aspects of the present invention. The coupler 200, in an exemplary aspect, allows for the pick-up tool 100 to be removeably attached to a moveable member. For example, as previously discussed, it is contemplated that the pick-up tool 100 is connected to a CNC robot. The CNC robot serves as a moveable member for positioning the pick-up tool 100 for manipulating and welding one or more parts.

FIG. 4 depicts an internal view of the pick-up tool 100 along cutline 4-4 of FIG. 1, in accordance with aspects of the present invention. FIG. 4 illustrates a vacuum channel 116 passing through an interior volume 124 of the horn 104. For example, in a traditional horn, the interior volume 124 may be continuously solid to effectively transfer mechanical vibration from the converter 102 to a to-be-welded part. However, a solid horn is incapable of providing an internal vacuum channel 116, as illustrated in FIG. 4.

As previously discussed with respect to FIG. 1, the pick-up tool 100 in this aspect relies on an external vacuum generator. Therefore, a vacuum force is introduced to the horn 104 by way of the vacuum source port 111. The vacuum force is then transferred through the interior volume of the horn 104 by way of the vacuum channel 116. The vacuum channel continues to extend towards the horn distal end 122. The horn distal end 122 is proximate the horn tip 106 proximal end 134.

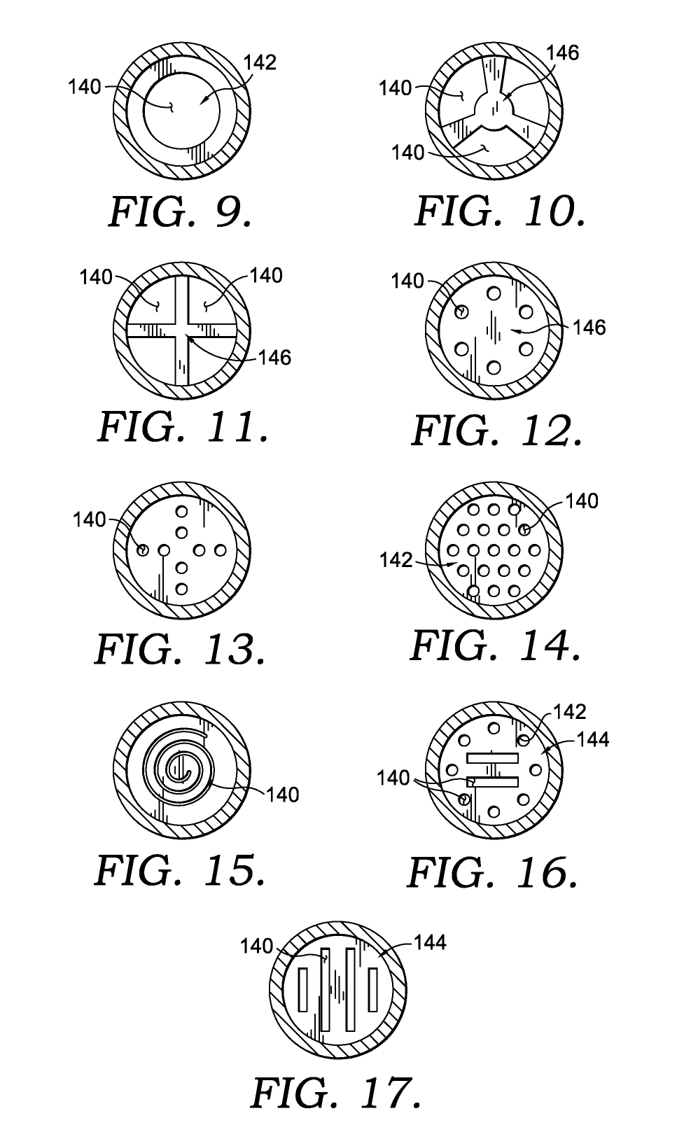

The horn tip 106 includes an aperture 140 that transfers the vacuum force to a defined area at the horn tip 106 distal end 136. In an exemplary aspect, as illustrated in FIG. 4, the aperture 140 is a single circular aperture; however, it is contemplated that additional configurations of the aperture 140 may be utilized (e.g., FIGS. 9-17). In this example, the horn tip 106 distal end 136 also forms at least a portion of the part-contacting distal end 121.

While a particular aspect of the vacuum source port 111 and the vacuum channel 116 are depicted in FIG. 4, additional orientations, configurations, sizes, dimensions, and the like are also contemplated. For example, the vacuum channel 116 may extend only within the horn tip 106, such that both the vacuum source portion 111 and the aperture 140 are maintained within the horn tip 106.

FIG. 5 depicts an internal view of the pick-up tool 100 along cutline 5-5 of FIG. 2, in accordance with aspects of the present invention. The pick-up tool 100 of FIG. 5 depicts an internal venturi-effect vacuum pump. While a particular configuration is illustrated, it is contemplated that additional configurations may be implemented.

Internal generation of a vacuum force, in this example, leverages incoming pressurized air to generate a vacuum force. For example, pressurized air is introduced to the interior of the horn 104 by way of the air-supply inlet 108. The pressurized air passes from the air-supply inlet 108 to a vacuum generator 128 through an air-supply channel 114. The exemplary vacuum generator 128 of FIG. 5 relies on a venturi effect to generate a vacuum force; however, it is also contemplated that a coanda effect may also be utilized in alternative configurations.

Within the horn 104, the vacuum force is transferred from the interior of the horn 104 to the vacuum inlet 110 by way of a vacuum channel 116. Further, air from the air supply and air pulled in through the vacuum inlet 110 are expelled from the interior of the horn 104 at an exhaust port 112 by way of an exhaust channel 118.

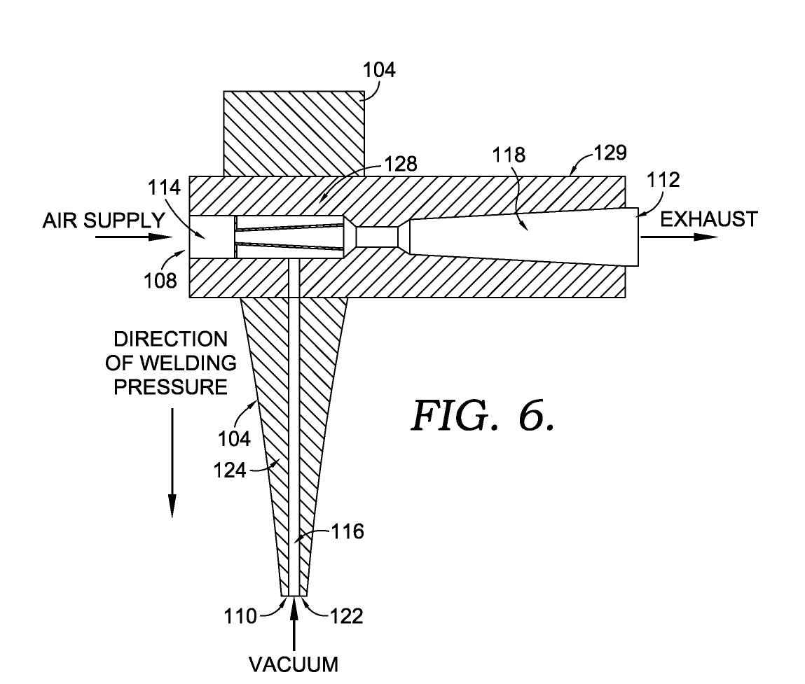

FIG. 6 depicts an internal view of an exemplary pick-up tool 100 utilizing an alternative internal vacuum mechanism, in accordance with aspects of the present invention. In this example, the internal generation of a vacuum force may be accomplished with a cartridge insert 129. For example, a vacuum generator may be produced that is functional for being inserted into a horn 104 to generate a desired amount of vacuum force. For example, manufacturing limitations may limit, in some examples, an amount of internal formation of channels and components within the horn 104. As such, it may be desired, in an exemplary aspect, to allow for a cartridge insert that contains the applicable portions needed for the generation of a vacuum force internally of the horn 104 without requiring the complexity of integrally forming the portions within the horn 104. As such, it is contemplated that the horn 104 may be configured to receive a cartridge that is capable of generating a vacuum force that is conveyed internally through the horn 104.

In this example, while the cartridge insert 129 is a discrete component from the horn 104, the cartridge insert 129 is considered a portion of the horn 104 when used in combination. As such, components internal to the cartridge insert 129 are therefore internal to the horn 104.

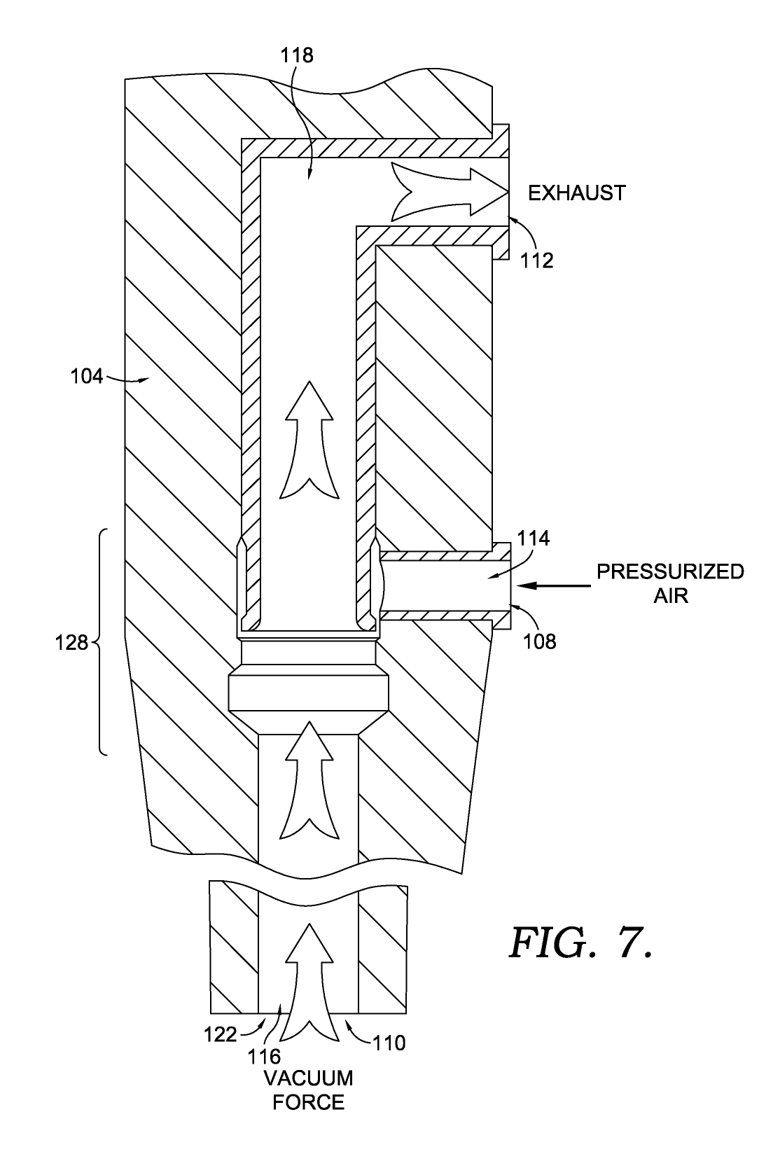

FIG. 7 depicts an exemplary horn 104 having a coanda effect internal vacuum generator 128, in accordance with aspects of the present invention. Similar to a venturi vacuum generator discussed with respect to FIG. 5, a coanda effect vacuum pump generates a vacuum force utilizing a supply of pressurized air. The pressurized air is received at the horn 104 at the air-supply inlet 108. The pressurized air is then transferred to the vacuum generator 128 by way of the air-supply channel 114. A vacuum channel 116 transfers air pulled into the vacuum inlet 110 to the vacuum generator 128. The exhaust channel 118 transfers the pressurized air (now at a lower pressure) and any air introduced into the interior of the horn 104 by way of the vacuum inlet 110 to the exhaust port 112.

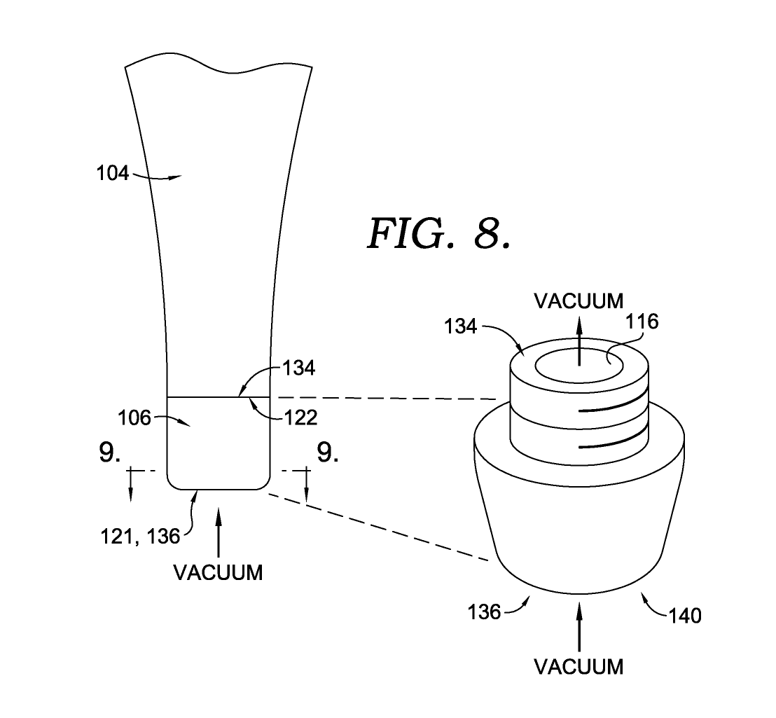

FIG. 8 depicts an exemplary horn 104 coupled with an exemplary horn tip 106, in accordance with aspects of the present invention. In particular, the horn tip 106 is exploded in view from the horn 104 to provide a prospective view of the vacuum channel 116 extending to the aperture 140. Further, exemplary threading is depicted as a means for detachably coupling the horn tip 106 and the horn 104. FIG. 8 includes a cutline 9-9 which is used to depict a parallel plane in the following FIGS. 9-17.

FIGS. 9-17 depict exemplary aperture combinations extending through the distal end 136 of the horn tip 106, in accordance with aspects of the present invention. For example, a circular aperture 142 (e.g., as seen in FIG. 9), a non-circular aperture (e.g., as seen in FIG. 17), and/or combinations of various apertures (e.g., as seen in FIG. 16) are depicted by FIGS. 9-17. It is contemplated that the depicted structures are exemplary in nature and not limiting as to aspects contemplated herein. For example, one or more structures depicted may be combined/modified with one or more other structures depicted in FIGS. 9-17.

Exemplary aspects of the present invention incorporate a non-porous center portion 146 in the distal end 136 of the horn tip 106. For example, it is contemplated that the non-porous center portion 146 (e.g., as seen in FIGS. 10-12) is an effective portion of the horn tip 106 for transferring a sufficient portion of the mechanical vibrations from the pick-up tool 100 to a to-be-welded part. In an exemplary aspect, the non-portion center portion 146 does not include an aperture and therefore provides a continuous portion of an exterior surface 138 of the distal end 136 for the horn tip 106 to contact a weldable part.

However, it is contemplated that any portion of the exterior surface 138 of the distal end 136 may be effective for contacting the weldable part by the pick-up tool 100. Additionally, other geometries are contemplated herein. For example, it is contemplated that a horn tip 106 may be comprised of more or fewer apertures 140. Further, different geometries (e.g., circle, rectangular, triangular, and the like) may be utilized. Different sizes (in combination or consistently) may be utilized for the various apertures 140. Further, various combinations of sizes, geometries, and or orientations of the apertures 140 is also contemplated herein.

Exemplary aspects are provided herein for illustrative purposes. Additional extensions/aspects are also contemplated in connection with aspects of the present invention. For example, a number, size, orientation, and/or form of components, portions, and/or attributes are contemplated within the scope of aspects of the present invention.

The invention claimed is:

1. An ultrasonic welding vacuum tool comprising:
a converter for converting electrical input into an ultrasonic mechanical vibration;
a horn coupled to the converter for transferring the ultrasonic mechanical vibration to a part-contacting distal end of the horn, the horn comprised of a vacuum channel; and
the vacuum channel extending from an exterior surface of the horn through an interior portion of the horn to the part-contacting distal end of the horn.

2. The ultrasonic welding vacuum tool of claim 1, wherein the part-contacting distal end of the horn is comprised of a horn tip.

3. The ultrasonic welding vacuum tool of claim 2, wherein the horn tip is removeably coupled to the horn.

4. The ultrasonic welding vacuum tool of claim 2, wherein the horn tip is comprised of a distal end and a proximal end, the proximal end couples to the horn and the distal end forms the part-contacting distal end of the horn.

5. The ultrasonic welding vacuum tool of claim 4, wherein the distal end of the horn tip is comprised of a single aperture.

6. The ultrasonic welding vacuum tool of claim 4, wherein the distal end of the horn tip is comprised of a plurality of apertures.

7. The ultrasonic welding vacuum tool of claim 4, wherein the distal end of the horn tip is comprised of a plurality of apertures at least partially surrounding a non-porous center portion of the distal end.

8. The ultrasonic welding vacuum tool of claim 4, wherein the distal end of the horn is comprised of a circular aperture.

9. The ultrasonic welding vacuum tool of claim 4, wherein the distal end of the horn is comprised of a non-circular aperture.

10. The ultrasonic welding vacuum tool of claim 1, wherein the vacuum channel form at least a portion of a vacuum pump.

11. The ultrasonic welding vacuum tool of claim 1, wherein the vacuum channel form at least a portion of a venturi vacuum pump.

12. The ultrasonic welding vacuum tool of claim 1, wherein the vacuum channel forms at least a portion of a coanda effect vacuum pump.

13. The ultrasonic welding vacuum tool of claim 1, wherein the vacuum channel is coupled to a vacuum force generator.

14. An ultrasonic welding vacuum tool comprising:
an ultrasonic welding horn (“horn”) for transferring ultrasonic vibrations from a proximal end to a distal part-contacting end, the horn comprising:
(1) an air-supply inlet, the air-supply inlet configured for receiving a supply of air at a pressure greater than the ambient air pressure;
(2) a vacuum inlet, the vacuum inlet configured for transferring a vacuum force from an interior portion of the horn to an exterior portion of the horn proximate the distal part-contacting end;
(3) an exhaust port, the exhaust port configured to expel air from the air-supply inlet and the vacuum inlet; and
(4) a vacuum generator, the vacuum generator coupled to the air-supply inlet, the vacuum inlet, and the exhaust port.

15. The ultrasonic welding vacuum tool of claim 14 further comprising a converter, the converter configured to convert electrical input into an ultrasonic mechanical vibration, the horn is coupled to the converter such that the ultrasonic mechanical vibration is transferred from the converter to the horn.

16. The ultrasonic welding vacuum tool of claim 14, wherein the horn further comprising a horn tip, the horn tip coupled to the horn and forming the distal part-contacting end.

17. The ultrasonic welding vacuum tool of claim 16, wherein the horn tip is comprised of an aperture, the aperture extending from an exterior portion of the horn tip to the vacuum inlet.

18. The ultrasonic welding vacuum tool of claim 16, wherein the horn tip is formed from a rigid material.

19. The ultrasonic welding vacuum tool of claim 16, wherein the horn tip is formed from a metallic material or a polymer-based material.

20. The ultrasonic welding vacuum tool of claim 14, wherein the vacuum generator is comprised of an air supply channel, a vacuum channel, and an exhaust channel, the air supply channel couples the vacuum generator with the air-supply inlet, the vacuum channel couples the vacuum generator with the vacuum inlet, and the exhaust channel couples the vacuum generator with the exhaust port.

21. The ultrasonic welding vacuum tool of claim 20, wherein the air supply channel, the exhaust channel, and the vacuum channel are each at least partially internal to the horn.

22. The ultrasonic welding vacuum tool of claim 14, wherein the vacuum generator is configured to utilize a venturi effect or a coanda effect when generating a vacuum force.

23. A vacuum tool comprising:
a converter, the converter configured to convert an electrical input into an ultrasonic vibration functional for ultrasonic welding of one or more parts;
a horn, the horn having a horn proximal end and an opposite horn distal end, the horn proximal end coupled with the converter;
a vacuum channel extending through at least a portion of an internal volume of the horn, the vacuum channel extending to the horn distal end; and
a horn tip, the horn tip having a horn tip proximal end and a horn tip distal end, the horn tip proximal end couple with the horn distal end and an aperture extending from the horn tip distal end to the horn tip proximal end such that the aperture is alignable with the vacuum channel.
